(19) United States
(12) Patent Application Publication
(10) Pub. No.: US 2022/0258188 A1
(43) Pub. Date: Aug. 18, 2022

(54) HYGIENIC CONTROLLED DROPLET APPLICATOR DEVICES, SYSTEMS, AND METHODS

(71) Applicant: Apeel Technology, Inc., Goleta, CA (US)

(72) Inventors: Edwin Spurling, Goleta, CA (US); Cody Hegel, Goleta, CA (US)

(21) Appl. No.: 17/665,799

(22) Filed: Feb. 7, 2022

Related U.S. Application Data
(60) Provisional application No. 63/146,917, filed on Feb. 8, 2021.

(51) Int. Cl. B05B 3/10; B05B 15/55

(52) U.S. Cl. CPC B05B 3/1035; B05B 15/55

(57) ABSTRACT

A fluid dispensing system is described herein. In some embodiments, the fluid dispensing system includes a CDA cone constructed as a unitary body; a motor comprising a sealed housing resistant to liquid ingress, the motor configured to rotate the CDA cone around a central longitudinal axis of the CDA cone; and a reducer tube configured to deliver a fluid solution to the CDA cone.

### CROSS-REFERENCE TO RELATED APPLICATIONS

The present application claims priority to patent application 63/146,917, filed on Feb. 8, 2021.

### TECHNICAL FIELD

This document describes devices, systems, and methods relating to hygienic applicator equipment, such as hygienic operation and cleaning of a controlled droplet applicator for use in product coating lines.

### BACKGROUND

Agricultural and other products can be treated, for example, with protective coatings or sanitizing agents which reduce or eliminate bacteria or other biotic stressors. Industrial equipment which either automates the processes or more easily facilitates carrying out the processes has been used. Some processing lines include controlled droplet applicators that deliver a liquid coating material onto products.

### SUMMARY

Reducing the number and type of microorganisms or contaminants on agricultural and other products can improve product quality. Incorporation of sanitization steps for removal of microbial material, such as brushing, washing, and/or sterilization can reduce microbial loading on products, such as fruit and vegetables, and on equipment for handling products.

Various embodiments described herein facilitate hygienic application of coating materials to products. In some examples, product line equipment includes one or more features that promote reduced microbial load harbored on the equipment over a period of operation, and/or facilitate cleaning and maintenance.

In some embodiments, example equipment includes a controlled droplet applicator (CDA) assembly. The CDA assembly optionally includes one or more of a CDA cone configured to generate substantially uniformly sized droplets through centrifugal force, a motor configured to rotate a CDA cone at a predetermined rotational speed, and a feeder tube that delivers fluid to the CDA cone. The components are constructed to reduce buildup of coating material or contaminants and/or to facilitate cleaning operations. For example, the motor is rated according to a predetermined dust and/or moisture resistance requirement (e.g., Ingress Protection Code 69K (IP69K), Ingress Protection Code 67 (IP67), Ingress Protection Code 66 (IP66), etc.). The CDA cone is optionally a unitary component. In some embodiments, the CDA cone does not include interfacing surfaces except an interfacing surface for attachment with a motor shaft. The feeder tube provides a low resistance flow path for applied solutions, and in some embodiments includes curved portions that have a relatively large radius of curvature. Fluid contact surfaces of the feeder tube and CDA cone have few or limited interfacing surfaces or small corners, and are constructed from hygienic materials, such as stainless steel. In some optional embodiments, the CDA cone and/or reducer tube include treated surfaces that have been deburred or otherwise polished to low roughness.

In an optional embodiment, the equipment is in fluid communication with a source of liquid coating solution. During application, the coating solution flows through the reducer tube and into the CDA cone. The CDA cone spins at a rotational speed that imparts centrifugal force on the coating solution. The centrifugal force causes the solution to spread across the inner surface of the CDA cone. The liquid solution pass through openings in the CDA cone and exits the CDA cone as droplets. The speed of rotation of the CDA cone and liquid solution flow rate affect droplet size.

Some embodiments of the devices, systems, and techniques described herein may provide one or more of the following advantages. First, some embodiments described herein facilitate hygienic cleaning of the CDA during clean-in-place (CIP) procedures. For example, cleaning of the CDA can be facilitated by a CDA cone constructed from a single piece of material. Unitary construction can reduce mated joints where foreign particles can become lodged and can increase cleaning solution flow across CDA cone features.

Second, various example embodiments include a curved feeder tube constructed with rounded corners (e.g., high radius of curvature). The curved feeder tube directs coating solution to the CDA cone while promoting laminar solution flow within the feeder tube. Rounded corners reduce turbulent flow and reduce build-up and coating material deposits within the reducer tube. Alternatively or additionally, cleaning solution directed through the reducer tube during CIP procedures faces less resistance and can travel with increased flow rate, promoting increased build-up removal.

Third, various example embodiments prevent harbored microbial load through motor constructed to standards that satisfy contaminate ingress criteria, reducing coating or cleaning solution build up within the motor casing. For example, IP66 and IP67 standards prevent liquid ingress under conditions commonly found under CIP procedures of up to 100 liters of cleaning solution per minute at 100 kPa (15 psi) at distance of 3 meters (9.8 ft).

Fourth, various example embodiments reduce harbored microbial load on equipment by constructing solution-contacting components out of hygienic materials. For example, metallic components constructed from stainless steel or other hygienic materials can be mechanically or electropolished to reduce shear stress between the tube surface and solution and reduce turbulent flow, and increase solution flow rates. Such construction can prevent solution build up within the CDA system and improve cleaning efficacy.

Fifth, various example embodiments described herein provide a modular CDA assembly that facilitates efficient assembly and disassembly. The system can be regularly disassembled for cleaning and maintenance operations. Alternatively or additionally, components of the system can be individually replaced or configured.

Sixth, various example embodiments described herein facilitate enhanced system performance and/or customizability. For example, one, two, three, four, or more CDA assemblies (e.g., each including a motor and CDA cone) can be attached to a frame of the system to generate a selectable spray pattern/area/delivery rate. Alternatively or additionally, in some embodiments, a height of CDA assemblies (e.g., relative to products to be coated) can be adjusted to generate a desired spray pattern/area (e.g., for different products, liquid compositions, etc.).

As additional description to the embodiments described below, the present disclosure describes the following embodiments.

Embodiment 1 is a fluid dispensing system, including a CDA cone constructed as a unitary body; a motor including a sealed housing resistant to liquid ingress, the motor configured to rotate the CDA cone around a central longitudinal axis of the CDA cone; and a reducer tube configured to deliver a fluid solution to the CDA cone.

Embodiment 2 is the fluid dispensing system of embodiment 1, wherein the CDA cone includes an outer wall; an inner disc having an upper surface and a lower surface; and a plurality of openings that extend between the upper surface and the lower surface.

Embodiment 3 is the fluid dispensing system of any one of embodiments 1-2, wherein the inner disc is at least partially sloped between the openings and a central portion that defines a shaft bore configured to receive a shaft of the motor.

Embodiment 4 is the fluid dispensing system of any one of embodiments 1-3, wherein the inner disc of the CDA cone has a slope between 1° and 5° relative to a horizontal plane perpendicular to the central longitudinal axis.

Embodiment 5 is the fluid dispensing system of any one of embodiments 1-4, wherein the plurality of openings includes between 3 and 5 openings.

Embodiment 6 is the fluid dispensing system of any one of embodiments 1-5, wherein the plurality of openings are arranged radially around a circumference of the inner disc.

Embodiment 7 is the fluid dispensing system of any one of embodiments 1-6, wherein the outer wall includes an inner surface that is angled relative to the central longitudinal axis of the CDA cone.

Embodiment 8 is the fluid dispensing system of embodiment 1-7, wherein the CDA cone defines an upper cavity having a first diameter at a top of the CDA cone.

Embodiment 9 is the fluid dispensing system of any one of embodiments 1-8, wherein the CDA cone has a lower cavity having a second diameter at a bottom of the CDA cone.

Embodiment 10 is the fluid dispensing system of any one of embodiments 1-9, wherein the second diameter is larger than the first diameter.

Embodiment 11 is the fluid dispensing system of any one of embodiments 1-10, including a rounded interface between the outer wall and the inner disc.

Embodiment 12 is the fluid dispensing system of any one of embodiments 1-11, wherein the rounded interface has a radius of curvature greater than 0.01 inches.

Embodiment 13 is the fluid dispensing system of any one of embodiments 1-12, wherein the reducer tube includes rounded corners that each have a radius of curvature greater than or equal to 0.75 inches.

Embodiment 14 is the fluid dispensing system of any one of embodiments 1-13, wherein the CDA cone and reducer tube are made from stainless steel.

Embodiment 15 is the fluid dispensing system of any one of embodiments 1-14, including a fluid pump configured to deliver a liquid to the reducer tube; and a controller in communication with the fluid pump and the motor, the controller configured to command the fluid pump to deliver the liquid to the reducer tube at a flow rate and the motor to rotate the CDA cone at a rotational speed.

Embodiment 16 is the fluid dispensing system of any one of embodiments 1-15, wherein the flow rate is greater than 40 mL/s.

Embodiment 17 is the fluid dispensing system of any one of embodiments 1-16, wherein the liquid includes a monoglyceride and fatty acid salt.

Embodiment 18 is the fluid dispensing system of any one of embodiments 1-17, wherein the liquid includes between 50% and 99% monoglyceride.

Embodiment 19 is the fluid dispensing system of any one of embodiments 1-18, wherein the liquid includes between 1% and 50% fatty acid salt.

Embodiment 20 is the fluid dispensing system of any one of embodiments 1-19, wherein the fatty acid salt includes a C16 fatty acid salt and a C18 fatty acid salt.

Embodiment 21 is the fluid dispensing system of any one of embodiments 1-20, wherein the fluid pump includes a peristaltic pump.

Embodiment 22 is a modular CDA system, including a CDA motor assembly, including a CDA cone; a reducer tube configured to deliver a liquid to the CDA cone; and a motor configured to rotate the CDA cone at a predetermined rotational speed; a pump assembly, including a fluid inlet; a fluid pump configured to pump fluid from the fluid inlet to the CDA motor assembly; and a controller configured to control operation of the fluid pump and the motor.

Embodiment 23 is the modular CDA system of embodiment 22, including a rail assembly, wherein the CDA motor assembly is adjustably mounted to the rail assembly.

Embodiment 24 is the modular CDA system of any one of embodiments 22-23, wherein a vertical height of the CDA motor assembly is adjustable.

Embodiment 25 is the modular CDA system of any one of embodiments 22-24, wherein the CDA cone includes an outer wall; an inner disc having an upper surface and a lower surface; and a plurality of openings that extend between the upper surface and the lower surface.

Embodiment 26 is the modular CDA system of any one of embodiments 22-25, wherein the inner disc of the CDA cone has a slope between 2° and 5° relative to a horizontal plane perpendicular to the central longitudinal axis of the CDA cone.

Embodiment 27 is the modular CDA system of any one of embodiments 22-26, including a rounded interface between the outer wall and the inner disc.

Embodiment 28 is the modular CDA system of any one of embodiments 22-27, wherein the CDA cone is made from stainless steel.

Embodiment 29 is the modular CDA system of any one of embodiments 22-28, wherein the pump includes a peristaltic pump.

Embodiment 30 is a cleaning method, including disassembling a CDA motor assembly, wherein disassembling includes arresting a shaft of a motor by applying torque to a flat on the shaft; removing a fastener from an end of the shaft; detaching a CDA cone from the shaft; removing one or more fasteners from a reducing collar, wherein the reducing collar includes a collar and a reducing tube; cleaning the CDA motor assembly by applying a cleansing material to the motor, reducing collar, and CDA cone; and reassembling the CDA motor assembly.

Embodiment 31 is the cleaning method of embodiment 30, wherein the CDA cone is constructed as a unitary body.

Embodiment 32 is the cleaning method any one of embodiments 30-31, wherein the disassembling is performed at a first time interval.

Embodiment 33 is the cleaning method any one of embodiments 30-32, further including spraying the CDA assembly in place at a second time interval.

Embodiment 34 is the cleaning method any one of embodiments 30-33, wherein the second time interval is less than the first time interval.

Embodiment 35 is the cleaning method any one of embodiments 30-34, wherein the CDA cone is made from stainless steel.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a perspective view of an example modular CDA system.

FIG. 2A is a front view of an example CDA motor assembly.

FIG. 2B is an exploded perspective view of the example CDA motor assembly of FIG. 2A.

FIG. 3 is a perspective view of an example tube and collar assembly.

FIG. 4 is a perspective view of an example collar.

FIG. 5A is a side view of an example CDA cone.

FIG. 5B is a cross-sectional view of the example CDA cone of FIG. 5A.

FIG. 5C is a top view of the example CDA cone of FIG. 5A.

FIG. 5D is a bottom view of the example CDA cone of FIG. 5A.

FIG. 6 is a perspective view of another example modular CDA system.

### DETAILED DESCRIPTION OF ILLUSTRATIVE EMBODIMENTS

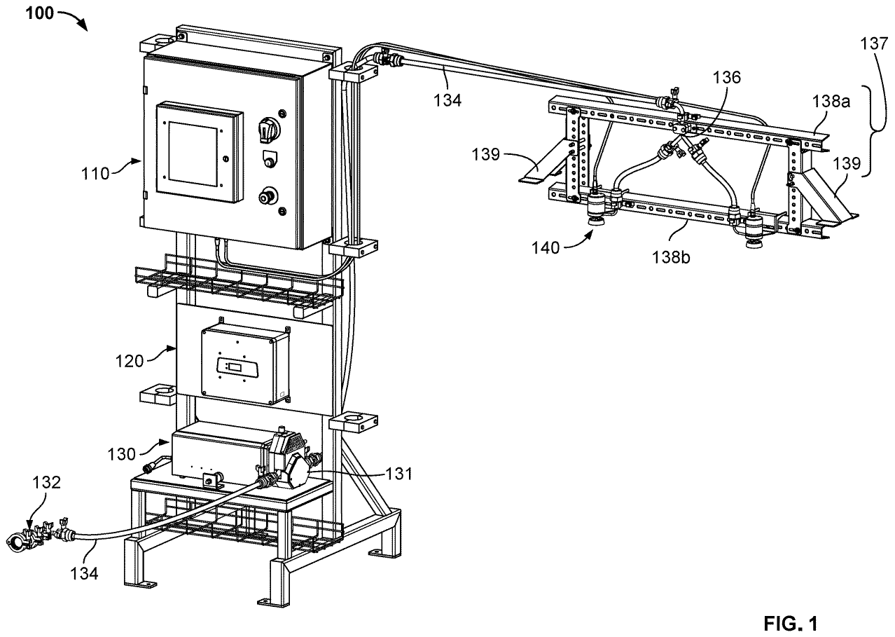

Referring to FIG. 1, a perspective view of an example modular controlled droplet applicator (CDA) system 100 is shown including a programmable logic controller (PLC) panel 110, a CDA pump controller 120, a pump assembly 130, and a CDA motor assembly 140. The CDA system 100 operates to dispense a liquid coating solution over products beneath the CDA motor assembly 140. The CDA system 100 is configured to treat (e.g., coat) products such as apples, citrus, berries, melons, peppers, tomatoes, leafy produce, fruits, vegetables, legumes, nuts, flowers, processed food items, candy, vitamins, nutritional supplements, and the like. In various embodiments, the CDA system 100 treats products selected from the group consisting of an apple, an apricot, an avocado, a banana, a blueberry, a bayberry, a cherry, a clementine mandarin, a cucumber, a custard apple, a fig, a grape, a grapefruit, a guava, a kiwifruit, a lime, a lychee, a mamey sapote, a mango, a melon, a mountain papaya, a nectarine, an orange, a papaya, a peach, a pear, a pepper, a persimmon, a pineapple, a plum, a strawberry, a tomato, a watermelon, and combinations thereof. Alternatively or additionally, the CDA system 100 treats non-agricultural products, including paper products, packaging, etc.

A PLC device 110a is an industrial digital computer adapted for the control of manufacturing processes including programmable memory used to store program instructions and various functions. The PLC panel 110 provides hardware modules capable of sending and receiving analog and digital signals between a PLC device 110a and additional components of the CDA system 100. In some embodiments, the PLC device 110a is housed within the PLC panel 110. In other example embodiments, the PLC device 110a is housed externally to the PLC panel and connected electronically with the hardware modules of the PLC panel 110.

The PLC device 110a can include at least one processor, a power supply, a memory unit storing instructions to be executed by the processor, an input/output (I/O) interface for receiving and transmitting data from and to connected devices, and/or a communications interface for receiving and transmitting data on communications networks (e.g., internet, LAN, WAN) to external computers or systems. The PLC device 110a controls primary functions of the CDA system 100 such as power (e.g., on, off), components in communication with the PLC panel 110 (such as CDA motor assembly 140), and/or emergency functions (e.g., emergency stop). In some embodiments, the PLC panel 110 includes one or more switches, relays, or controls, to provide the primary function control of the CDA system 100 in conjunction with the PLC device 110a.

The CDA pump controller 120 is a computing device storing instructions to operate dispensing components including a fluid pump and a CDA motor of the CDA system 100. The CDA pump controller 120 includes at least one processor, a power supply, and a memory unit storing instructions to be executed by the at least one processor. The CDA pump controller 120 is in communication with, directly or indirectly, the at least one fluid pump assembly 130 to provide power and operation instructions to the components such as pump speed, fluid flow rate, dispensing time, or motor assembly rotation rate.

The fluid pump assembly 130 is configured to draw fluid from a fluid source and/or deliver fluid to the CDA motor assembly 140. The fluid pump assembly 130 includes a fluid pump 131, fluid inlet 132, and fluid line 134. The fluid pump 131 receives or draws a fluid, such as a liquid coating material, through fluid inlet 132 from an external source in fluid communication with fluid inlet 132. In various example embodiments, the external source includes a storage vessel, drum, or tote, and/or an outlet from a mixing system (e.g., that mixes liquid coating material in real-time to be coated by CDA system 100).

In an example embodiment, the fluid pump 131 is a peristaltic pump. The peristaltic pump can efficiently pump liquid material while promoting hygienic operation due to limited or no contact with the liquid coating material. Alternatively or additionally, fluid pump assembly 130 can include other types of pumps (e.g., that provide consistent fluid pressure to the CDA motor assembly), including a rotary pump, diaphragm pump, or piston pump. In an example embodiment, fluid pump assembly 130 includes a single pump 130 that delivers liquid coating material to one or more CDA motor assemblies 140. Alternatively or additionally, fluid pump assembly 130 includes two or more pumps, and each pump is in fluid communication with only one or more than one CDA motor assembly 140. For example, the CDA system 100 can include one fluid pump 131 for each CDA motor assembly 140.

Liquid inlet 132 supplies liquid coating material to fluid pump assembly 130 and CDA motor assembly 140. For example, a single liquid inlet 132 (e.g., having a single connector location) is used to supply liquid coating material for CDA system 100 whether CDA system 100 includes a single fluid pump 131 or more than one fluid pump 131. Alternatively or additionally, the liquid coating material can be supplied by more than one liquid inlet 132, such as liquid inlets 132 associated with each fluid pump 131, or multiple liquid inlets 132 may be associated with individual pumps 131. In various example embodiments, multiple liquid inlets 132 may facilitate use of multiple different fluid sources, such as a first liquid inlet associated with a storage vessel and a second liquid inlet associated with a liquid coating material mixing system.

During operation, the liquid coating material flows through the fluid inlet 132 and fluid line 134 to an inlet side of the fluid pump 131. The fluid pump 131 maintains the flow rate and pressure of the coating material and directs the coating material through an outlet side of the fluid pump 131. In some embodiments, the outlet flow rate of the fluid pump is greater than 0.1 mL/s, such as greater than 1 mL/s, greater than 10 mL/s, greater than 20 mL/s, greater than 40 mL/s, greater than 50 mL/s, greater than 60 mL/s, greater than 100 mL/s or greater than 400 mL/s.

The fluid line 134 connects fluid-contacting components (e.g., vessel, fluid pump 131, and/or CDA motor assembly 140) of the CDA system 100. In various example embodiments, fluid line 134 includes flexible (e.g., polyurethane hose), semi-rigid (e.g., polyurethane tube) and/or rigid (e.g., stainless steel pipe) sections. The inner diameter of the fluid line 134 is sufficient to sustain the coating material flow rate and pressure generated by fluid pump 131. For example, the inner diameter of the fluid line 134 is between ¾″ (6 mm) to 2″ (50 mm). In general, fluid line 134 connecting external vessels to the fluid pump 131 is the same inner diameter and/or material construction as fluid line 134 connecting the fluid pump 131 to the CDA motor assembly 140. Though alternatively, fluid line 134 connecting external vessels to the fluid pump 131 is a different inner diameter and/or material construction as fluid line 134 connecting the fluid pump 131 to the CDA motor assembly 140. In some embodiments, the fluid pump 131 can have additional sections of fluid line including different inner diameters and/or material construction as fluid line 134 to achieve different flow rates.

During operation, the coating material travels from the outlet side of the fluid pump 131 through fluid line 134 connecting the fluid pump to the at least one CDA motor assembly 140 of the CDA system 100. In some embodiments, the fluid line 134 includes fittings, such as releasable connectors, elbows, unions, or tees, which facilitate assembly and disassembly during cleaning procedures, set-up, repair, or system transport.

In some embodiments, the CDA system 100 includes a manifold 136, such as a “Y” connector, that distributes the coating material to CDA motor assemblies 140. In an example embodiment, the manifold 136 includes a “Y” connector in fluid communication with two CDA motor assemblies 140. Manifold 136 may be manipulable or controllable (e.g., by PLC 110 and/or CDA pump controller 120) to selectively open or close fluid flow to one or more of the CDA motor assemblies 140.

The CDA motor assemblies 140 are mounted to a rail assembly 137. The rail assembly 137 provides an adjustable mounting system for the CDA motor assemblies 140. The CDA motor assemblies 140 are removably mounted to horizontal frame 138 in a selected position relative to a product line or product to be coated. For example, the CDA motor assemblies 140 can be mounted at any horizontal position using the rail mount. In an example embodiment, rectangular frame 138 is supported by two angled arms 139.

The angled arms 139 support the frame 138 and facilitate vertical position adjustment for attached components, such as the CDA motor assemblies 140 (e.g., relative to a product line located beneath CDA motor assemblies 140). The ends of the angled arms 139 can be placed upon or affixed to a secondary support structure, such as a coating line conveyor frame that conveys product beneath the CDA motor assemblies 140. Alternatively or additionally, the vertical position of CDA motor assemblies can be adjustable by adjusting an attachment location of CDA motor assembly upwardly or downwardly (e.g., to the horizontal frame components 138a, 138b), and/or adjusting a vertical position of the horizontal frame component on the vertical frame component.

The CDA motor assemblies 140 spray or otherwise distribute droplets of a liquid coating material (e.g., a solution, suspension, emulsion, etc.) over the surface of a product to be coated. In some embodiments, the CDA motor assemblies distribute between 1 mL/s and 50 mL/s of the liquid coating material during the coating application process (e.g., between 5 mL/s and 30 mL/s, or between 10 mL/s and 20 mL/s). The liquid coating material can include a coating agent (e.g., a solute) in a solvent. Once the item is covered with the coating material, it is subjected to a drying operation (e.g., by passing beneath blower exhausts) which facilitates controlled removal (e.g., via evaporation) of the solvent, forming a protective coating of the coating agent on the surface of the product.

For example, the drying operation can include passing the item along a drying path (e.g., through a drying tunnel) in which a blower pushes hot air into the system and/or fans along the length provide additional airflow. In another example, the drying operation uses a pressure buildup with a perforated plate to supply high velocity air across the product path. In some embodiments, temperature set points for the drying operation are between 45-95° C., 50-90° C., 55-85° C., or 65-80° C. The drying operation may use direct fire burners. The drying operation includes, in some embodiments, air recirculation, and optionally humidity control systems with the addition of a ventilation duct and modulating exhaust. High pressure blowers may be provided to supply air to a perforated plate. This can facilitate a high velocity of air across the product path.

In some implementations, a single coating is applied to the product. Alternatively or additionally, multiple coatings (e.g., of the same or different coating material) may be applied by multiple CDA systems 100 or by passing the product through CDA system 100 multiple times. In some embodiments, 2, 3, 4, or 5 coatings are applied to the product.

The protective coating material formed from the coating material delivered by CDA system 100 can be used to prevent food spoilage due to moisture loss, oxidation, or infection by a foreign pathogen. In an example embodiment, the coating material includes a solvent that includes water, an alcohol (e.g., ethanol, methanol, isopropanol, or combinations thereof), acetone, ethyl acetate, tetrahydrofuran, or combinations thereof. The coating material can, for example, include monoacylglycerides, fatty acids, esters (e.g., fatty acid esters), amides, amines, thiols, carboxylic acids, ethers, aliphatic waxes, alcohols, fatty acid salts, organic salts, inorganic salts, or combinations thereof.

The coating mixture may include a water-based solution. The coating mixture may include a monoglyceride and a fatty acid salt. In some embodiments, the monoglyceride can be present in the mixture in an amount of about 50% to about 99% by mass. In some embodiment, the monoglyceride can be present in the coating mixture in an amount of about 90% to about 99% by mass. In some embodiments, the monoglyceride can be present in the coating mixture in an amount of about 95% by mass. In some embodiments, the monoglyceride includes monoglycerides having carbon chain lengths longer than or equal to 10 carbons (e.g., longer than 11, longer than 12, longer than 14, longer than 16, longer than 18). In some embodiments, the monoglyceride includes monoglycerides having carbon chain lengths shorter than or equal to 20 carbons (e.g., shorter than 18, shorter than 16, shorter than 14, shorter than 12, shorter than 11, shorter than 10). In some embodiments, the monoglyceride includes a C16 monoglyceride and a C18 monoglyceride. In some embodiments, the fatty acid salt can be present in the coating mixture in an amount of about 1% to about 50% by mass. In some embodiments, the fatty acid salt can be present in the coating mixture in amount of about 1% to about 10% by mass. In some embodiments, the fatty acid salt can be present in the coating mixture in an amount of about 5% by mass. In some embodiments, the fatty acid salt includes a C16 fatty acid salt, a C18 fatty acid salt, or a combination thereof. In some embodiments, the fatty acid salt includes a C16 fatty acid salt and a C18 fatty acid salt. In some embodiments, the C16 fatty acid salt and the C18 fatty acid salt are present in an approximate 50:50 ratio. In some embodiments, the coating mixture further comprises additives, including, but not limited to, cells, biological signaling molecules, vitamins, minerals, acids, bases, salts, pigments, aromas, enzymes, catalysts, antifungals, antimicrobials, time-released drugs, and the like, or a combinations thereof. In some embodiments, the coating mixture can be applied to the product in the form of a solution, suspension, or emulsion with a concentration of the coating mixture of about 1 g/L to about 50 g/L.

In some implementations, the coating agent includes monomers, oligomers, or combinations thereof, including esters or salts formed thereof. In some implementations, the solutions/suspensions/colloids include a wetting agent or surfactant which cause the solution/suspension/colloid to better spread over the entire surface of the substrate during application, thereby improving surface coverage as well as overall performance of the resulting coating. In some implementations, the solutions/suspensions/colloids include an emulsifier which improves the solubility of the coating agent in the solvent and/or allows the coating agent to be suspended or dispersed in the solvent. The wetting agent and/or emulsifier can each be a component of the coating agent, or can be separately added to the solution/suspension/colloid.

In various example embodiments, coatings described herein can be at least about 40%, at least about 45%, at least about 50%, at least about 55%, at least about 60%, at least about 65%, at least about 70%, at least about 75%, at least about 80%, at least about 85%, at least about 90%, at least about 95%, or at least about 99% water by mass or by volume. In some implementations, the solvent includes a combination of water and ethanol, and can optionally be at least about 40%, at least about 45%, at least about 50%, at least about 55%, at least about 60%, at least about 65%, at least about 70%, at least about 75%, at least about 80%, at least about 85%, at least about 90%, at least about 95%, or at least about 99% water by volume. In some implementations, the solvent or solution/suspension/colloid can be about 40% to 100% water by mass or volume, about 40% to 99% water by mass or volume, about 40% to 95% water by mass or volume, about 40% to 90% water by mass or volume, about 40% to 85% water by mass or volume, about 40% to 80% water by mass or volume, about 50% to 100% water by mass or volume, about 50% to 99% water by mass or volume, about 50% to 95% water by mass or volume, about 50% to 90% water by mass or volume, about 50% to 85% water by mass or volume, about 50% to 80% water by mass or volume, about 60% to 100% water by mass or volume, about 60% to 99% water by mass or volume, about 60% to 95% water by mass or volume, about 60% to 90% water by mass or volume, about 60% to 85% water by mass or volume, about 60% to 80% water by mass or volume, about 70% to 100% water by mass or volume, about 70% to 99% water by mass or volume, about 70% to 95% water by mass or volume, about 70% to 90% water by mass or volume, about 70% to 85% water by mass or volume, about 80% to 100% water by mass or volume, about 80% to 99% water by mass or volume, about 80% to 97% water by mass or volume, about 80% to 95% water by mass or volume, about 80% to 93% water by mass or volume, about 80% to 90% water by mass or volume, about 85% to 100% water by mass or volume, about 85% to 99% water by mass or volume, about 85% to 97% water by mass or volume, about 85% to 95% water by mass or volume, about 90% to 100% water by mass or volume, about 90% to 99% water by mass or volume, about 90% to 98% water by mass or volume, or about 90% to 97% water by mass or volume.

Coating agents formed from or containing a high percentage of long chain fatty acids and/or salts or esters thereof (e.g., having a carbon chain length of at least 14) have been found to be effective at forming protective coatings over a variety of substrates that can prevent water loss from and/or oxidation of the substrate. The addition of one or more medium chain fatty acids and/or salts or esters thereof (or other wetting agents) can further improve the performance of the coatings.

In some embodiments, the coating material further includes antimicrobial compounds to deactivate microbes during and following dispensation from CDA system 100. Antimicrobial compounds added to the liquid coating material can be essential oils derived from plants (e.g., basil, thyme, oregano, cinnamon, clove, and rosemary), enzymes obtained from animal sources (e.g., lysozyme, lactoferrin), bacteriocins from microbial sources (e.g., nisin, natamycin), organic acids (e.g., sorbic, propionic, citric acid), molecular or element compounds (e.g., gold, copper, or silver), and naturally occurring polymers (e.g., chitosan). The antimicrobial activity can depend on the chemical structure of the antimicrobial compound, including the presence of hydrophilic functional groups, such as hydroxyl groups of phenolic components.

The CDA system 100 includes hygienic materials and component construction to increase the efficacy of CIP procedures and reduce microbial load and coating material build up on interior coating material contact surfaces. For example, CDA system 100 facilitates cleaning procedures, such as clean-in-place (CIP) procedures that can be performed on regular schedules to increase hygienic operation and decrease contaminants and microbial load present on the CDA system 100. Such cleaning procedures reduce the presence of build-up within and on component surfaces of the CDA system 100, particularly on components involved in dispensing coating material, such as the CDA motor assemblies 140.

In general, CIP procedures include cleaning interior surfaces of CDA system 100 that contact coating material, including surfaces of process pipes, vessels, and equipment. Cleaning and/or sanitizing materials can be introduced to the CDA system 100 via fluid inlet 132 and advanced through the CDA system 100 via fluid pump 131.

Alternatively or additionally, CDA system 100 facilitates cleaning procedures that include disassembling and cleaning of components that contact the liquid coating material, including pump assembly 130, CDA motor assemblies 140, and rail assembly 137. Such components are removably secured to CDA system 100, which can reduced the time to disassemble the components of CDA system 100. Alternatively or additionally, various components are designed as unitary bodies, e.g., constructed from or into single components, reducing crevices and being composed primarily or entirely of exposed surfaces from which contaminants or residual coating material can be removed, and reducing the parts of CDA system 100 for cleaning.

In various example embodiments, CDA system can be cleaned using CIP techniques according to a first interval or cleaning schedule, and cleaned using deep cleaning procedures according to a second interval or cleaning schedule that is less frequent than CIP procedures. For example, a method of cleaning CDA system 100 includes one or more CIP techniques applied at daily intervals, and cleaning by disassembling CDA system 100 (e.g., including removing components of CDA motor assembly 140) at monthly intervals.

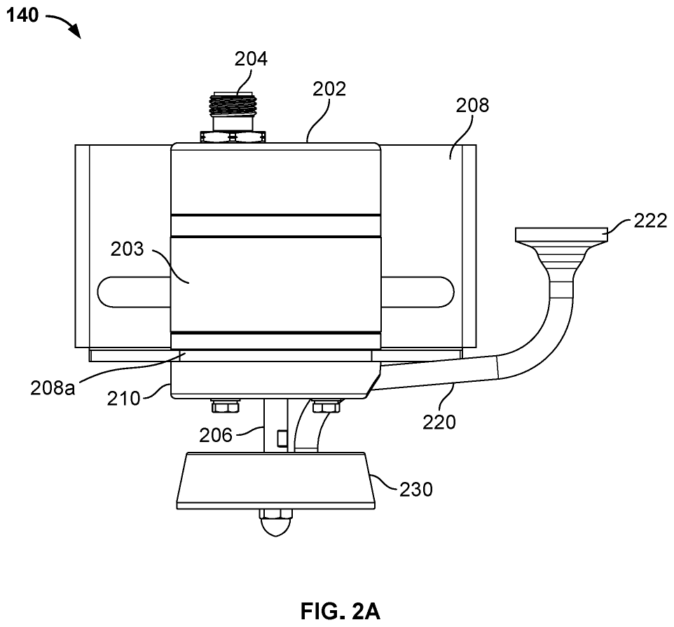

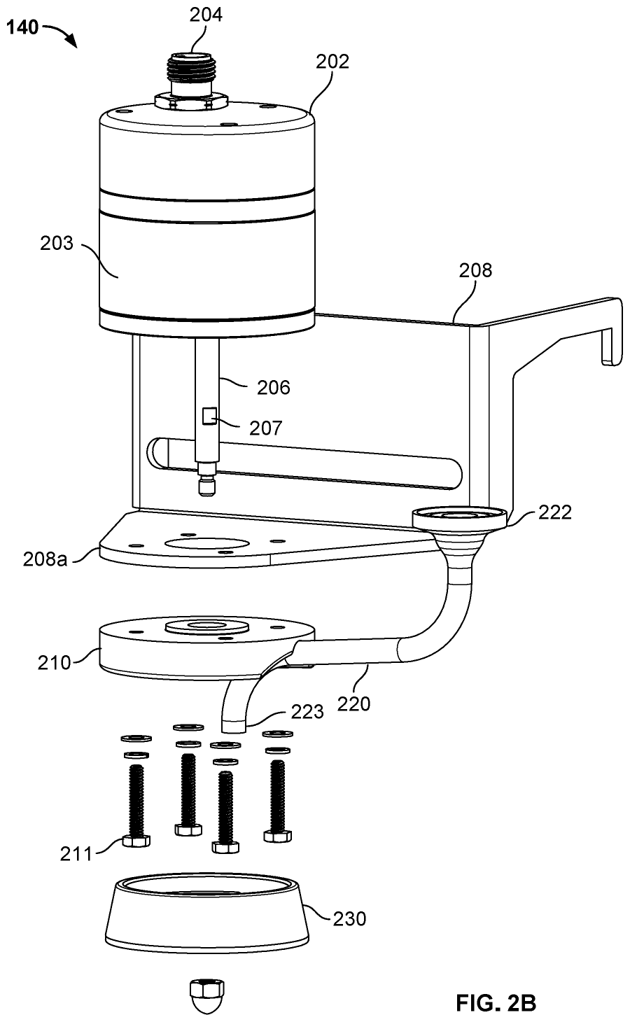

FIGS. 2A and 2B illustrate CDA motor assembly 140, including motor 202, collar 210, liquid reducer tube 220, and CDA cone 230. During operation, liquid coating material is distributed to the CDA cone 230 via liquid reducer tube 220. The CDA cone 230 is rotated by motor 202 to dispense liquid coating material.

The motor 202 is constructed to withstand exposure to liquids, such as liquid coating material and/or cleaning liquids. A liquid resistant construction facilitates operational reliability and cleaning procedures (e.g., involving wash-down of motor 202). In an example embodiment, the motor 202 includes a housing 203 which is constructed to meet or exceed IP66 and/or IP67 standards for contaminate (e.g., dust or liquid) ingress. In some embodiments, the housing 203 is constructed to meet or exceed IP 69K standards. For example, the housing 203 prevents liquid ingress under conditions commonly found under CIP procedures, such as up to 100 liters of cleaning solution per minute at 100 kPa (15 psi) at distance of 3 meters (9.8 ft). Such a construction facilitates frequent wash-down cleaning operations in which exposed surfaces of motor 202 is sprayed with a liquid cleaning solution.

The motor 202 includes electric connection port 204 for communication with the PLC panel 110 through which the motor 202 receives commands (e.g., for controlling the rotational speed of the motor shaft 206). In some embodiments, the electric connection port 204 and the opening for the motor shaft 206 are constructed to prevent liquid ingress (e.g., consistent with IP66/IP67 standards).

The CDA motor assembly 140 includes one or more components, such as reducer tube 220, collar 210 and CDA cone 230, constructed from hygienic materials. For example, reducer tube 220, collar 210 and/or CDA cone 230 are constructed from non-reactive, impact-resistant, and easily cleaned and/or sanitized materials.

The CDA motor assembly 140 includes surfaces treated to promote hygienic operation of CDA system 100 and/or improve cleanability. In an example embodiment, component surfaces are polished (e.g., electropolished) to low surface roughness (Rₐ) to promote hygienic operation of CDA system 100. In some embodiments, the components include surfaces having an Rₐ that is less than or equal to 32 micro inches (0.8 μm or 32.5 RMS). For example, low Rₐ the components can have surfaces having an Rₐ of 30 micro inches, 25 micro inches, 20 micro inches, or 15 micro inches or lower can promote hygienic operation by reducing microbial load and/or other contaminants present during operation of the CDA motor assembly 140, and/or reducing coating material build up within and on exterior surfaces of the components.

FIG. 2B depicts an exploded perspective schematic view of the CDA motor assembly 140 of FIG. 2A. The motor 202 is adjustably mounted to rail mount 208 with one or more fasteners 211 that secure the collar 210 to the motor 202. In an example embodiment, the fasteners 211 extend through smooth bores of the collar 210 and rail mount extension 208a, and into the housing 203 thereby securing the collar 210 to the motor 202 and affixing the motor to the rail mount 208. In the example of FIG. 2B, four fasteners 211 are depicted though more or fewer fasteners 211 can secure the collar 210 to the motor 202 (e.g., three or fewer, or five or more fasteners). In various example embodiments, few or no threads are exposed when CDA motor assembly 140 is assembled for operation.

The reducer tube 220 directs coating material supplied from the fluid line 134 to the CDA cone 230 from which the coating material is dispensed to the product beneath. In an example embodiment, the reducer tube 220 is composed of rigid material (e.g., stainless steel) and includes a fluid connection 222 (e.g., a reducer) at a first end and an outlet opening at a second, opposing end 223. The fluid connection 222 reduces the flow path inner diameter from that of the fluid line 134 to that of the reducer tube 220. In some embodiments, the inner diameter of the flow path is reduced from 0.37 inches (e.g., the inner diameter of the fluid line 134) to 0.18 inches (e.g., the inner diameter of the reducer tube 220). The reducer tube 220 includes at least one elbow to facilitate redirection of the coating material flow path from adjacent the motor 202 to adjacent the shaft 206.

When assembled, the shaft 206 extends through an opening in the rail mount 208, a central bore of the collar 210, and a central bore of the CDA cone 230. The shaft includes a flat surface 207 that facilitates an operator to applying torque to the shaft 206 without spinning the shaft 206. The flat surface 207 facilitates disassembly for cleaning procedures, while reducing damage to motor.

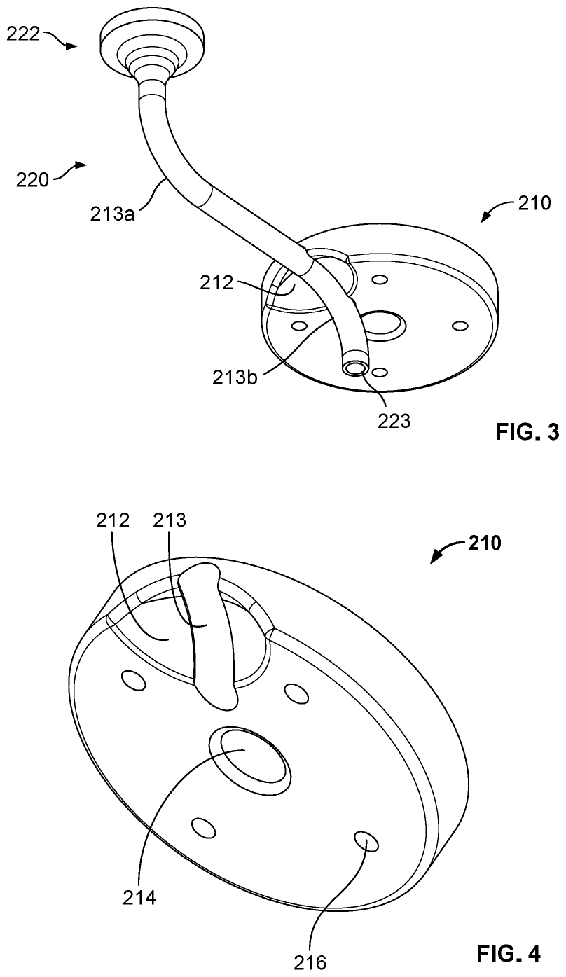

Referring now to FIG. 3, a perspective schematic view of the arrangement of the reducer tube 220 and collar 210 is shown. The collar includes a curved recess 212 inset into the primary body of the collar 210. For example, the reducer tube 220 includes two elbows 213a and 213b. The first elbow adjacent the fluid connection 222 extends an 85° arc such that the subsequent straight section creates a 5° downward slope with respect to the horizontal. The second elbow extends an 85° arc in the same plane as the first elbow but in the opposite direction such that the fluid flow path exiting the open end 223 of the reducer tube 220 is parallel with the fluid flow path entering the fluid connection 222.

The elbows of the reducer tube 220 have large radii of curvature (R_{C}) with respect to the inner diameter of the reducer tube 220. In general, the pipe R_{C} is measured to the centerline axis of symmetry within the interior volume of the pipe. In an example embodiment, the R_{C} of the pipe surface proximal to the center of curvature (inner radius R_{I}) is equal to R_{C} minus ½ of the pipe inner diameter (e.g., ID) minus the wall thickness

$$( {R}_{I} = {R}_{C} - \frac{1}{2} ID - {t}_{w} ) .$$

Similarly, the R_{C} of the pipe surface distal to the center of curvature (outer radius R_{O}) is equal to R_{C} plus ½ of the pipe inner diameter plus the wall thickness

$$( {R}_{O} = {R}_{C} + \frac{1}{2} ID + {t}_{w} ) .$$

Elbows with comparatively large radii of curvature, for example R_{C}≥1.5*ID, reduce the presence of turbulent flow and dead zones (e.g., areas of comparatively low pressure) as fluid traverses the elbow. Such geometry can reduce material build up and increase laminar flow during cleaning procedures. In some embodiments, elbow R_{C} is three times or more greater than the inner diameter of reducer tube 220. Following the example above, the inner diameter of the reducer tube 220 is 0.18″ and the R_{C} of one or both elbows is 0.75″.

Referring to FIG. 4, the collar 210 is shown. The collar 210 is cylindrical in shape with a diameter greater than the thickness. The collar 210 includes four smooth-bore cylindrical holes 216 traversing the thickness of the collar 210 through which fasteners 211 pass when affixed to the motor 202. In alternative embodiments, the collar 210 can include more or fewer holes 216, such as two, three, five, or six holes. In general, the diameter of the holes 216 is greater than the diameter of the shaft of the fasteners 211 but lower than the diameter of the head of the fasteners 211. The collar 210 further includes a central shaft aperture 214 through which the shaft 206 extends when the CDA motor assembly 140 is affixed to the rail mount 208. In general, the shaft aperture 214 diameter is greater than the shaft 206 aperture. In some embodiments, the diameter of the four holes 216 is 0.144″ and the diameter of the shaft aperture 214 is 0.4″.

The collar 210 includes a second recession 213 within recess 212. The second recession 213 is circular in cross-sectional profile and curved to complement the R_{O} curvature of the reducer tube 220 second elbow, e.g., the inner diameter of the second recession 213 matches the outer diameter (OD) of reducer tube 220.

The reducer tube 220 second elbow seats at least partially within the second recession 213 to position the open end 223 near the CDA cone 230 in operation. In some embodiments, the reducer tube 220 second elbow is permanently affixed to the second recession 213 to reduce fluid ingress during CIP procedures. For example, the reducer tube 220 second elbow can be welded to the second recession 213.

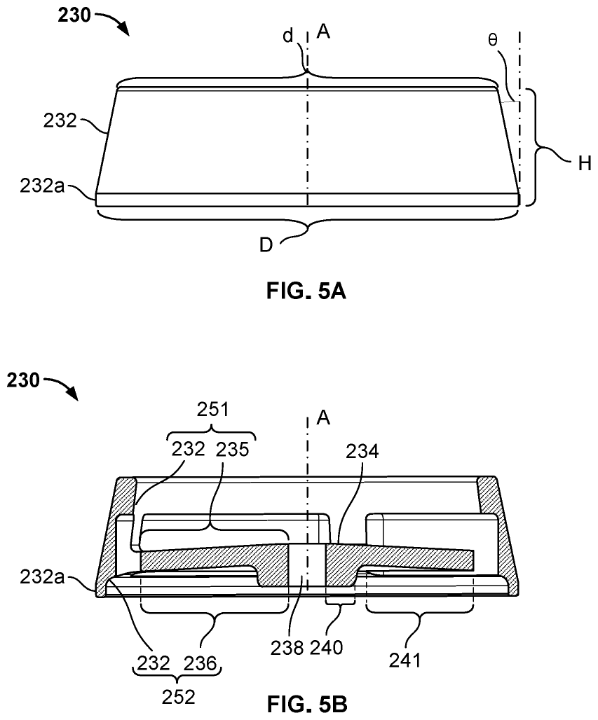

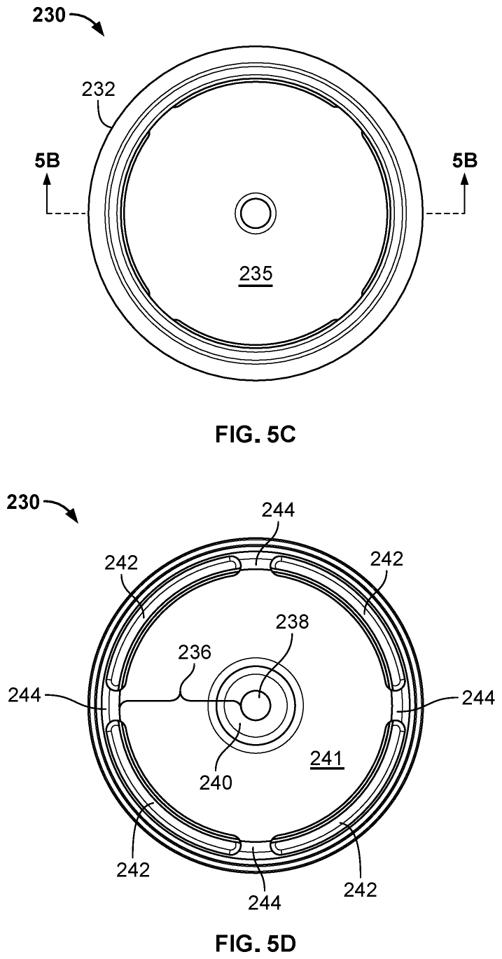

The CDA cone 230 is shown in FIGS. 5A-5D. The CDA cone 230 includes a first outer diameter (D) at the base 232a (e.g., lower most edge) and a second outer diameter (d) at the top edge (e.g., upper most edge). In an example embodiment, outer wall 232 is angled relative to the central longitudinal axis (A). For example, the first outer diameter (D) of the wall 232 is greatest proximate the base 232a and tapers to a second, minimum outer diameter (d) proximate the top edge. An outer surface of wall 232 (e.g., extending between the lower most and upper most edges) forms an angle (θ) with respect to the central longitudinal axis of between 0° and 20°, 5° and 15° or about 11.5°. The wall 232 at least partially defines upper and lower cavities that receive liquid coating composition, direct liquid coating composition through openings 242, and promotes rotational stability.

In an example embodiment, the CDA cone 230 includes a ‘cup’ shape defined at least partially by an outer wall 232 and an inner disc 234 (FIG. 5B). The outer wall 232 and an upper surface 235 of the inner disc 234 at least partially define an upper cavity 251, and the outer wall 232 and a lower surface 236 of the inner disc 234 at least partially define a lower cavity 252. One or more openings extend between the upper cavity 251 and the lower cavity 252. During operation, liquid coating material is dispensed into the upper cavity (e.g., onto the upper surface 235 from tube 220). Rotation of the CDA cone 230 causes the liquid coating material to flow outwardly away from a center of CDA cone 230, through openings 242, and into the lower cavity 252. In an example embodiment, the liquid coating material is dispensed from the CDA cone 230 from the base 232a or feature of outer wall 232 and/or the lower surface 236 of inner disc 234.

The upper surface 235 of inner disc 234 is angled with respect to a horizontal plane orthogonal to the central axis of rotation (A), and/or a lower surface 236. In various example embodiments, the upper surface 235 is angled at between 2° and 5° relative to a plane orthogonal to the central axis of rotation (A). For example, the upper surface 235 is angled about 3° downward.

The dimensions of the CDA cone 230 can be selected based upon the fluid parameters of the coating material being applied, desired application pattern, rotational speed, and other operational parameters. In various example embodiments, a maximum outer diameter (D) of the base 232a of the wall 232 is between 1″ and 18″, 1.5″ and 6″, 2″ and 2.5″, or about 2.125″.

CDA cone 230 includes a shaft bore 238 through which the shaft 206 extends, defining the central axis of rotation (A) (e.g., the central axis). In an example embodiment, a material thickness of disc 234 is largest in a radial region 240 surrounding the shaft bore 238. The radial region 240 provides increased mechanical strength where the shaft is affixed to the CDA cone 230. In some embodiments, the radial region 240 extends to a radius of 0.25″ from the central axis. In some embodiments, the radial region 240 is proportional to the shaft bore 238 diameter (e.g., 50%, 100%, or 150% of the diameter). The thickness of the disc 234 decreases past the radial region 240 to join a constant thickness extension 241 parallel with the upper surface 235. In some embodiments, the thickness of the disc 234 varies, such that upper and lower surfaces 235, 236 of disc 234 taper to different degrees or in different directions.

Referring now to FIGS. 5C and 5D, a top view of the CDA cone 230 (FIG. 5C), and a bottom view of the CDA cone 230 (FIG. 5D) are shown. The openings 242 are located around the circumference of the lower surface 236, proximate wall 232. In an example embodiment, openings 242 have an arc shape. The inner disc 234 is connected to the wall 232 by four bridges 244. In various example embodiments, CDA cone 230 includes two, three, four, or more than four bridges 244 and openings 242. For example, the CDA cone 230 can include two or more, for example, between 3 and 5, bridges 244 and openings 242.

In an example embodiment, openings 242 each extend equal arc lengths. Such a configuration can promote balanced rotation and consistent delivery of liquid coating material from CDA cone 230. In some embodiments, openings 242 have non-equal arc lengths, and/or asymmetric shapes. In some embodiments, the combined arc length of one opening 242 and one adjacent bridge 244 is equal to 360° divided by the number of openings 242. For example, the CDA cone 230 includes four openings 242 and bridges 244; therefore one opening 242 and one adjacent bridge 244 extend a total arc length of 90° (360°/4). The arc length ratio of the opening arc length, aₒ, to the bridge arc length, a_{b}, can be any values such that aₒ>a_{b}. For example, the aₒ of the depicted openings 242 and a_{b} of the bridges 244 is 70° and 20°, respectively. The width along the radial axis of each opening 242 can be between 0.1″ and 0.25″, for example, 0.125″.

In an example embodiment, the CDA cone 230 is constructed from a single piece of hygienic material, such as stainless steel. A unitary construction reduces interfaces between discrete components such that coating material and microbial build up during operation of the CDA system 100 is reduced, and/or can be readily removed. Alternatively or additionally, a unitary construction can promote improved flow of cleaning materials during CIP procedures, promoting full coverage of cleaning materials. The CDA cone 230 can be effectively cleaned in place and/or be removing CDA cone 230 from CDA motor assembly 140.

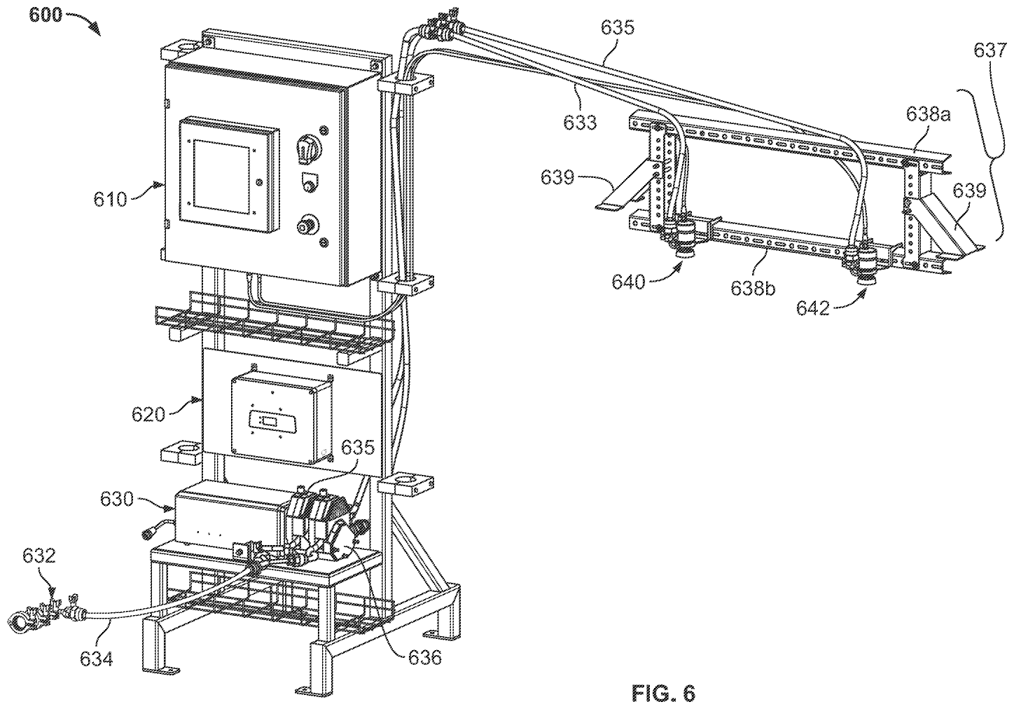

As discussed above, in some embodiments, the fluid pump assembly 130 can include more than one fluid pump 131. In some embodiments, the fluid pressure delivered to each CDA motor assembly 140 by a respective fluid pump 131 can be controlled to a high level of consistency with relatively decreased pressure fluctuations. Alternatively or additionally, the quantity and/or rate of fluid delivered to each CDA motor assembly 140 can be individually controlled. Referring to FIG. 6, a perspective view of an example modular controlled droplet applicator (CDA) system 600 is shown including a programmable logic controller (PLC) panel 610, a CDA pump controller 620, a pump assembly 630, and a CDA motor assembly 640. In various example embodiments, the system 600 includes one or more features described above with reference to FIGS. 1-5.

The pump assembly 630 includes two fluid pumps, fluid pump 635 and fluid pump 636. Both fluid pump 635 and fluid pump 636 include peristaltic pumps, though in some embodiments, fluid pumps 635 and 636 include any pumps listed herein, for example. Fluid pumps 635 and 636 are in fluid connection with respective CDA motor assemblies 640 and 642, e.g., fluid pump 635 is in fluid connection with CDA motor assembly 640 by way of fluid line 635 and fluid pump 636 is in fluid connection with CDA motor assembly 642 by way of fluid line 637.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A fluid dispensing system, comprising:
a CDA cone constructed as a unitary body;
a motor comprising a sealed housing resistant to liquid ingress, the motor configured to rotate the CDA cone around a central longitudinal axis of the CDA cone; and
a reducer tube configured to deliver a fluid solution to the CDA cone.

2. The fluid dispensing system of claim 1, wherein the CDA cone comprises:
an outer wall;
an inner disc having an upper surface and a lower surface; and
a plurality of openings that extend between the upper surface and the lower surface.

3. The fluid dispensing system of claim 2, wherein the inner disc is at least partially sloped between the openings and a central portion that defines a shaft bore configured to receive a shaft of the motor.

4. The fluid dispensing system of claim 2, wherein the inner disc of the CDA cone has a slope between 1° and 5° relative to a horizontal plane perpendicular to the central longitudinal axis.

5. The fluid dispensing system of claim 2, wherein the plurality of openings comprises between 3 and 5 openings arranged radially around a circumference of the inner disc.

6. The fluid dispensing system of claim 5, wherein the outer wall includes an inner surface that is angled relative to the central longitudinal axis of the CDA cone.

7. The fluid dispensing system of claim 1, wherein the CDA cone defines an upper cavity having a first diameter at a top of the CDA cone and a lower cavity having a second diameter at a bottom of the CDA cone, wherein the second diameter is larger than the first diameter.

8. The fluid dispensing system of claim 2, comprising a rounded interface between the outer wall and the inner disc, wherein the rounded interface has a radius of curvature greater than 0.01 inches.

9. The fluid dispensing system of claim 8, wherein the reducer tube includes rounded corners that each have a radius of curvature greater than or equal to 0.75 inches.

10. The fluid dispensing system of claim 1, comprising:
a fluid pump configured to deliver a liquid to the reducer tube; and
a controller in communication with the fluid pump and the motor, the controller configured to command the fluid pump to deliver the liquid to the reducer tube at a flow rate and the motor to rotate the CDA cone at a rotational speed.

11. The fluid dispensing system of claim 10, wherein the flow rate is greater than 40 mL/s.

12. The fluid dispensing system of claim 10, wherein the fluid pump comprises a peristaltic pump.

13. A modular CDA system, comprising:
a CDA motor assembly, comprising:
a CDA cone;
a reducer tube configured to deliver a liquid to the CDA cone; and
a motor configured to rotate the CDA cone at a predetermined rotational speed;
a pump assembly, comprising:
a fluid inlet;
a fluid pump configured to pump fluid from the fluid inlet to the CDA motor assembly; and
a controller configured to control operation of the fluid pump and the motor.

14. The modular CDA system of claim 13, comprising a rail assembly, wherein the CDA motor assembly is adjustably mounted to the rail assembly.

15. The modular CDA system of claim 13, wherein the CDA cone comprises:
an outer wall;
an inner disc having an upper surface and a lower surface; and
a plurality of openings that extend between the upper surface and the lower surface.

16. The modular CDA system of claim 15, wherein the inner disc of the CDA cone has a slope between 2° and 5° relative to a horizontal plane perpendicular to a central longitudinal axis of the CDA cone, and further comprising a rounded interface between the outer wall and the inner disc.

17. The modular CDA system of claim 13, wherein the pump comprises a peristaltic pump.

18. The modular CDA system of claim 13, wherein the system further comprises a second CDA motor assembly, and a second pump assembly, wherein the controller is further configured to control operation of the second CDA motor assembly, and the second pump assembly.

19. A cleaning method, comprising:
disassembling a CDA motor assembly, wherein disassembling comprises:
arresting a shaft of a motor by applying torque to a flat on the shaft;
removing a fastener from an end of the shaft;
detaching a CDA cone from the shaft;
removing one or more fasteners from a reducing collar, wherein the reducing collar comprises a collar and a reducing tube;
cleaning the CDA motor assembly by applying a cleansing material to the motor, reducing collar, and CDA cone; and
reassembling the CDA motor assembly.

20. The cleaning method of claim 19, wherein the disassembling is performed at a first time interval, and further comprising spraying the CDA motor assembly in place at a second time interval, wherein the second time interval is less than the first time interval.
